(19) United States
(12) Patent Application Publication
(10) Pub. No.: US 2022/0193663 A1
(43) Pub. Date: Jun. 23, 2022

(54) ACOUSTOFLUIDIC DEVICE

(71) Applicant: University College Cardiff Consultants Limited, Cardiff South Glamorgan (GB)

(72) Inventor: Xin Yang, Cardiff South Glamorgan (GB)

(73) Assignee: University College Cardiff Consultants Limited, Cardiff South Glamorgan (GB)

(21) Appl. No.: 17/599,703

(22) PCT Filed: Mar. 26, 2020
(86) PCT No.: PCT/EP2020/058531

§ 371 Date: Sep. 29, 2021

(30) Foreign Application Priority Data
Apr. 2, 2019 (GB) 1904601.0

(51) Int. Cl. B01L 3/00; B01D 21/28; B06B 1/02; B06B 1/06

(52) U.S. Cl. CPC B01L 3/50273; B01D 21/283; B06B 1/0238; B06B 1/0688; B06B 2201/77; B01L 2300/0861; B01L 2400/0436; B01L 2400/0439; B01L 2200/0652

(57) ABSTRACT

The invention concerns a novel acoustofluidic device to separate acoustically active particles from fluids comprising a novel device arrangement for improved acoustic pressure and particle velocity; and a method of separating particles from a fluid comprising use of same.

### FIELD OF THE INVENTION

The invention concerns a novel acoustofluidic device to separate acoustically active particles from fluids comprising a novel device arrangement for improved acoustic pressure and particle velocity; and a method of separating particles from a fluid comprising use of same.

### BACKGROUND OF THE INVENTION

Acoustophoresis is the separation of particles using acoustic wave. It has been known that acoustic wave can exert forces on particles in the acoustic field which can be determined by the particles' volume, density and compressibility. The pressure profile in a standing acoustic wave contains areas of net zero pressure at the nodes and of maximum at the anti-nodes. Depending on the acoustic contract factor of the particles, they will be trapped at the pressure nodes or pressure anti-nodes of the standing acoustic wave.

A wide range of acoustofluidic devices integrating a channel and acoustic transducer have been developed for applications in biochemistry and biomedicine. Acoustofluidic technology involves the use of acoustic radiation force to generate acoustic pressure across a flow channel. Recently, acoustofluidic manipulation of microparticles (i.e. particles with dimensions between about 0.1 and about 1000 μm) such as bacteria, blood cells, circulating tumour cells (CTCs) and extracellular vesicles, has received attention in biochemical, biophysical, and biomedical areas due to its biocompatible, versatile, contactless and label-free advantages.

Devices based on surface acoustic waves (SAWs) producing acoustophoretic motion independent of the acoustic impedance ratio at the boundary which allows the water-filled channel to be made from either acoustically hard (e.g. silicone, pyrex) or soft materials (e.g. polydimethylsiloxane (PDMS)). SAWs versatility also enables droplet actuation with free boundary conditions. SAW based acoustophoretic devices integrate an acoustic source and channel, where the acoustic energy is coupled to fluid in the channel via the soft and/or hard walls defining said channel.

The principle of the separation by SAW devices is driven by the primary acoustic radiation force F^{rad}, and acoustic streaming drag force F^{drag} induced by the acoustic waves. Due to the attenuation of the acoustically soft channel material, acoustic waves propagating inside the channel are absorbed into the channel material resulting in acoustic energy loss. Techniques have been explored to manipulate the particle in the channel and controlling the movement along the vertical direction by adjusting the input power from the transducers, however, smaller particles require higher input power. Further, the height of channel further limits the size of samples that can be processed. Increasing the input power of the SAW device may be able to compensate the loss but the induced Joule heat on the interdigital transducers (IDTs) can damage the piezoelectric substrate, such as lithium niobate (LiNbO₃) which has high electro-mechanical coupling coefficient but poor thermal conductivity. Thus, the maximum power received by the SAW device is typically constrained by thermal stress produced by the IDTs on the substrate.

Therefore, conventional acoustophoresis devices have had limited efficacy due to several factors including inefficient heat dissipation and weak mechanical sustainability. Improved acoustophoresis devices using innovative acoustic structure are therefore desirable.

In this work, we have developed an alternative acoustofluidic device wherein we have employed a channel having a roof comprised of an active acoustic source. By doing so, significantly reduced acoustic energy loss and increased acoustic pressure inside the channel is achievable leading to vastly improved channel flow velocities compared to conventional devices. Further, the provision of an active acoustic source can be carefully controlled as an adjustable actuator, which can further increase the acoustic energy density in the channel to enhance acoustic manipulation of particles.

### STATEMENTS OF INVENTION

According to a first aspect of the invention there is provided an acoustofluidic device comprising:
at least one interdigitated transducer (IDT) deposited on the surface of a piezoelectric substrate; and
functionally coupled therewith at least one channel having a first end and second end forming a fluid flow path, wherein said channel is positioned adjacent said at least one IDT and comprises a first sidewall; a second sidewall; a floor and an acoustic wave source defining a roof of the channel.

Reference herein to an IDT refers to a transducer comprising two interlocking comb-shaped arrays of metallic electrodes (in the fashion of a zipper), also known as interdigital electrodes (IDEs). These metallic electrodes are deposited on the surface of a piezoelectric substrate to form a periodic structure and, upon application of radio frequency (RF) voltage, convert electric signals to surface acoustic waves (SAW) by generating periodically distributed mechanical forces via a piezoelectric effect causing the substrate to expand and contract. In the case of the present arrangement, when an RF voltage is applied to the at least one IDT this generates a single travelling SAW within the piezoelectric substrate that propagates toward the channel positioned adjacent thereto. Without wishing to be bound by theory, internal reflection of the SAW from the channel wall reflects the SAW towards the IDT in a counter direction such that the outgoing SAW and reflected SAW travel towards one another wherein they interfere to generate a standing surface acoustic wave (SSAW) field of periodic pressure nodes and pressure antinodes in channel.

More preferably, the device comprises at least a pair of interdigitated transducers (IDTs) deposited on the surface of a piezoelectric substrate to form at least one SSAW transducer wherein the at least one channel is positioned between said at least one pair of IDTs. As is known to those skilled in the art, SSAW transducers comprise a piezoelectric substrate patterned with at least two interdigital transducers IDTs

According to this preferred embodiment of the invention, the at least one channel is positioned between said pair of IDTs at the point wherein the SSAW field is generated. While the SSAWs transmit along the fluid/solid interface of the channel(s) as a transverse wave, upon entering the fluid this becomes a longitudinal wave and causes a pressure field inside the fluid. As a result, particles suspended in the fluid are subjected to lateral acoustic forces due to the acoustic radiation and pressure fluctuations, which allow manipulation of the particles by changing the parameter of the IDTs such as input power, frequency, length, number of electrodes, and spacing between two IDTs.

Reference herein to a piezoelectric substrate refers to any material that exhibits a piezoelectric effect, that is the internal generation of electrical charge resulting from an applied mechanical force (and so also exhibit the reverse piezoelectric effect, that is the internal generation of a mechanical strain resulting from an applied electrical field). Examples include, but are not limited to, polyvinylidene difluoride (PVDF), Gallium Nitride (GaN), Aluminium nitride (AlN), Silicon carbide (SiC), Aluminum Gallium Nitride (AlGaN), Langasite (La₃Ga₅SiO₁₄), Gallium orthophosphate (GaPO₄), a Lithium niobate (LiNbO₃), Lithium tantalate (LiTaO₃), Barium titanate (BaTiO₃), Lead zirconate titanate (Pb[ZrₓTi₁₋ₓ]O₃ with 0≤x≤1, or more commonly known as PZT), Potassium niobate (KNbO₃), Sodium tungstate (Na₂WO₃), and Zinc oxide (ZnO). In a preferred embodiment of the invention, said piezoelectric substrate is Lithium niobate (LiNbO₃)

In a preferred embodiment, the longitudinal axis of said channel is substantially orthogonal with respect to said IDT(s). As will be appreciated, in this arrangement as fluid flows through said channel, acoustic wave forms generated by the IDT(s) are substantially transverse to the fluid flow path, thus exposing any particles present in the fluid to lateral pressure force permitting generation of fluid flow paths that allow separation of particles according to shape and/or size. Alternatively, the longitudinal axis of said channel is provided at an angle with respect to said IDT(s) (and therefore SAW generated by same), which results in the generation of a tapered SSAW within the channel to facilitate particle separation as the particles flow through the channel. Preferably, said angle is between 0 and 90 degrees or any 1 degree increment therebetween.

In a preferred embodiment, said channel floor is configured to functionally couple with the at least one IDT or SSAW transducer such that the travelling wave or SAWs, respectively, is propagated across same. As will be appreciated, in this preferred embodiment said floor of the channel is provided by the piezoelectric substrate wherein the walls of the channel are bonded to the surface of the substrate to provide a channel.

Alternatively, said channel floor and/or walls can be made from any suitable material that can house a fluid mixture and permits coupling of the acoustic wave energy from the piezoelectric substrate to the fluid in the channel. As is known by those skilled in the art, silicon, glass, or metal materials are commonly used for acoustophoresis because the rigid channel walls provide a near ideal acoustic boundary against the sample fluid, enhancing the required standing wave resonance. Such suitable materials for channel floor and/or wall include, but are not limited to, medical grade plastics, such as polycarbonates or polymethyl methacrylates, polyphenylsulfone (PPS), glass, silicone, ceramic, elastomers, thermoset polyester (TPE), poly-methyl methacrylate (PMMA), polystyrene (PS), polycarbonate (PC), poly-ethylene glycol diacrylate (PEGDA), teflons, polyurethane (PU), paper, hydrogels, pyrex and polydimethyl siloxane (PDMS). Most ideally, said channel walls and/or floor are PDMS and silicone. In yet a further preferred embodiment, the material may be configured to be transparent to permit visualisation of the flow of fluid during operation of the device.

Reference herein to an acoustic wave source refers to any means for generating acoustic wave energy wherein said acoustic wave energy is transmitted into the fluid of the channel. Without wishing to be bound by theory, it is believed that by providing a roof defined by an acoustic wave source one can further generate and enhance a vertical pressure field in the channel, in addition to the longitudinal pressure field induced by the substantially orthogonal IDT(s), producing another standing wave thereby increasing the channel pressure field. Further, the vertical channel pressure field also permits manipulation of particles in the vertical direction of the channel in addition to laterally.

In a preferred embodiment, said acoustic wave source is provided as a further at least one interdigitated transducer (IDT) deposited on the surface of a piezoelectric substrate or standing surface acoustic wave (SSAW) transducer as defined herein. Preferably, said acoustic wave source is provided as a further standing surface acoustic wave (SSAW) transducer as defined herein. As will be appreciated by those skilled in the art, in this arrangement the channel roof and floor is provided by two substantially opposing SSAW transducers which, with the channel walls, define the channel therebetween (SAW-SAW). In this arrangement one can achieve stronger pressure gradients in the channel, thus achieving increased flow rates compared to conventional arrangements known in the art. Further, by tuning the phase difference between the waves generated by the roof and floor SSAW transducers, the acoustic pressure distribution can be controlled permitting greater particle manipulation.

In a preferred embodiment of this arrangement, the IDT(s) deposited on the surface of the piezoelectric substrate and the acoustic wave source are configured such that, in use, a phase difference of between about Δφ=π/2 and Δφ=3π/2 exists between the acoustic wave(s) originating in the piezoelectric substrate (e.g. the floor SSAW transducer) and the acoustic wave(s) originating in the roof of the channel (e.g. the roof SSAW transducer). Most ideally, the phase difference is about Δφ=π, which has been found to produce four symmetrical pressure anti-nodes to form good particle trajectories.

In an alternative embodiment, and more ideally, said acoustic wave source is provided as a bulk acoustic wave (BAW) piezoelectric transducer producing bulk acoustic waves (BAWs). In this arrangement (called BAW-SAW) the channel floor is provided by the at least one IDT or SSAW transducer of the substrate and the roof is defined by a bulk acoustic (BAW) piezoelectric transducer. It has been found that in this particular arrangement one can also achieve stronger pressure gradients in the channel of several orders of magnitude greater than conventional arrangements known in the art. RF signals drive both the BAW and SSAW transducers to produce a combined acoustic energy in the channel. Changing the input voltage of the BAW and SSAW transducers can vary the integrated acoustic field. In a preferred embodiment of this arrangement, the vibration amplitude of the BAW transducer is at least two times the vibration amplitude of the SSAW transducer, more preferably at least five times, and most ideally at least ten times which has been found to produce four symmetrical pressure anti-nodes to form good particle trajectories.

In all embodiments, advantageously it has been found that the pressure gradients achievable can be further increased by cooling the at least one SSAW transducer such that increased input voltages can be applied and thus counter any excess heating of same.

In a preferred embodiment of this arrangement, said BAW piezoelectric transducer is a piezoelectric ceramic such as, but not limited to, PZT, LiNbO₃, or the like.

In a preferred embodiment, said channel has a width to height ratio of between about 10:1 and 1:1. More preferably, said channel has a width to height ratio of between about 6:1 and 3:1. In this arrangement, it has been found that where the channel dimensions are proportionally greater in width than height, maximum pressure field can be achieved across the entire cross-section of the channel allowing more careful particle manipulation.

In yet a further preferred embodiment, said channel has a width between about 10-1000 μm including every 1 μm therebetween. More preferably, said channel has a width between about 100-750 μm, and more preferably still between about 300-700 μm, and most preferably between about 400-650 μm.

In a yet further preferred embodiment, said channel has a height between about 1-250 μm including every 1 μm therebetween. More preferably, said channel has a height between about 25-200 μm, and most preferably between about 100-150 μm.

Channels of the following dimensions: (i) 600 μm (W)×125 μm (H); or (ii) 450 μm (W)×120 (H) are particularly suitable for use in the device of the present invention.

In yet a further preferred embodiment of the invention, the channel comprises at least one inlet configured to introduce a fluid into a proximal end portion of the channel. Additionally, or alternatively, the channel comprises at least one outlet which is located at a downstream portion of the channel positioned substantially along the longitudinal axis of the channel. Ideally, the channel comprises at least two outlets. As will be appreciated by those skilled in the art, in this embodiment, a fluid can be introduced through the first inlet and flowed through the at least one channel. Through exposure to the acoustic pressure generated by the SSAW transducer and/or acoustic wave source, particles present in the fluid can be separated into different specific outlets of the channel according to particle shape and/or size. Advantageously, the standing wave from the SSAW transducers and acoustic wave source can control movement of particles both laterally and vertically in channel. Preferably, said inlet(s) and/or outlet(s) are branched to permit separation of particles into different flow streams.

In yet a further preferred embodiment, said inlet(s) and/or outlet(s) comprise tubing to permit flow of a fluid into the inlet(s) and/or out of the outlet(s).

Preferably, said device comprises a pump to control flow rate of fluid through the inlet(s)/channel(s)/outlet(s).

In yet a further preferred embodiment still, said device comprises a plurality of channels in fluid communication with one another. Preferably, the channels are connected in series, so that each channel shares a connection with at least another channel. More preferably, each channel is connected via tubing. More preferably still each channel is functionally coupled with at least one IDT deposited on the surface of a piezoelectric substrate or a SSAW transducer such that each channel can separate different particles with respect to one another according to the standing wave generated for each respective channel. In this arrangement multi-stage particle separation can be achieved.

In yet a further preferred embodiment, the SSAW transducers and/or acoustic wave source can be operated in phase with each other, or operated out of phase with each other. Each SSAW transducer and/or acoustic wave source of the present disclosure may have individual electrical attachments (e.g. electrodes), so that each SSAW transducer and/or acoustic wave source can be individually controlled for frequency and power. Configuration allows for not only the generation of a multi-dimensional acoustic standing wave, but also improved control of the acoustic standing wave. In this way, it is possible to drive individual transducers with arbitrary phasing and/or different or variable frequencies and/or in various out-of-phase modes.

In yet a further preferred embodiment each SSAW transducer and/or acoustic wave source can generate a resonance frequency, or a mean resonance frequency, of between about 100 kHz to 1000 MHz and more preferably between about 1 MHz to 60 MHz.

In yet a further preferred embodiment, it may be required to modulate the frequency or voltage amplitude of the standing wave. This may be done by amplitude modulation and/or by frequency modulation.

As will be appreciated by those skilled in the art, the device disclosed therein herein can be used to separate acoustically active particles from fluids. For example, particles and cells (e.g., target particles) can be removed from a fluid based on the target particles' acoustic properties with respect to the fluid in which they are contained. The fluids can be biological based (e.g., a bodily fluid such as blood) or non-biological based (e.g., waste water). For example acoustic focusing of cells and particles is a technique that can be used in cytometric applications. Acoustic focusing can be implemented in devices for purifying and enriching samples prior to analysis of use of the samples for various applications such as prior to therapeutic injection or diagnosis. In some embodiments, a purified or enriched sample can be integrated into a conventional flow cytometer for further analysis. The acoustic manipulation of particles described herein can be used in clinical applications, requiring the separation of micro- and/or nano-particles. In some embodiments, the invention can be used to manipulate, separate and/or enrich viruses, cells, cell clusters, organisms, tissues, bacteria, exosomes, platelets, parasites, worms, nanotubes, fibres, beads, zebrafish, apoptotic bodies, microvesicles, lipoproteins, liposomes, aerosols, droplets and other nanoparticle and/or microparticle components in biological fluids. In some embodiments, the invention can be used to separate two different sizes of cells. In some embodiments, the invention can be used to separate two different sized cancer cells or to separate cancer cells or disease infected cells (e.g. pathogen infected cells) from healthy cells.

According to a second aspect of the invention, there is provided a method for separating a mixture of particles comprising use of the device as defined herein. As would be appreciated by those skilled in the art, such a method typically comprises suspending a mixture of acoustically active particles in a liquid flow stream and flowing said flow stream through the channel of the device of the first aspect invention, thereby exposing the flow stream in the channel to a standing acoustic wave field to affect acoustic fluid relocation of said acoustically active particles.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All references, including any patent or patent application, cited in this specification are hereby incorporated by reference. No admission is made that any reference constitutes prior art. Further, no admission is made that any of the prior art constitutes part of the common general knowledge in the art.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The Invention will now be described by way of example only with reference to the Examples below and to the following Figures wherein:

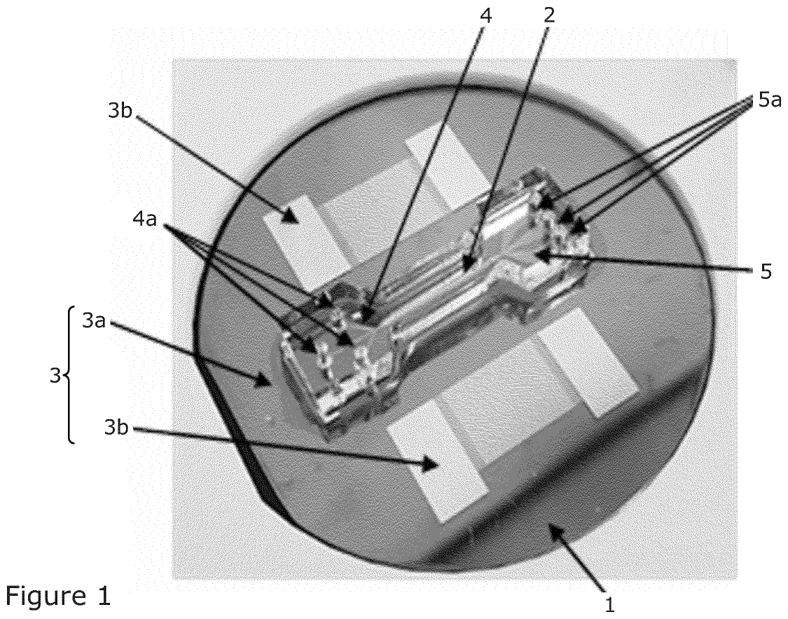

FIG. 1. A partial side sectional view of the acoustofluidic device according to the invention;

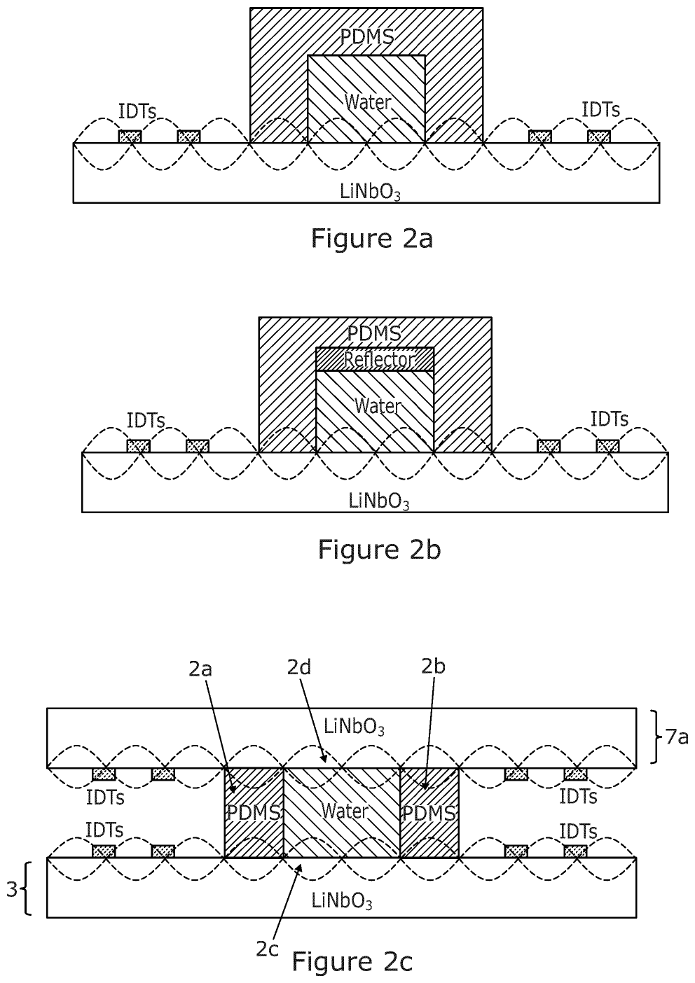

FIG. 2. Cross sectional side views of the channels of the state of the art (a-b) and according to the invention (c-d). (a) A typical acoustofluidic structure consisting of a PDMS channel and a SSAW transducer (SAW-PDMS). (b) A hybrid acoustofluidic resonator employing a glass slide as the reflector positioned at the top of the PDMS channel (SAW-Glass). (c) An acoustofluidic configuration equipped by two SSAW transducers as the top and bottom plates (SAW-SAW). (d) An integrated acoustofluidic configuration consisting a top BAW transducer and a bottom SAW transducer (BAW-SAW). (e) The computational domain of the model, the boundary Γₜ, Γ_{b}, and Γₛ are modelled as the top, bottom and side walls, respectively;

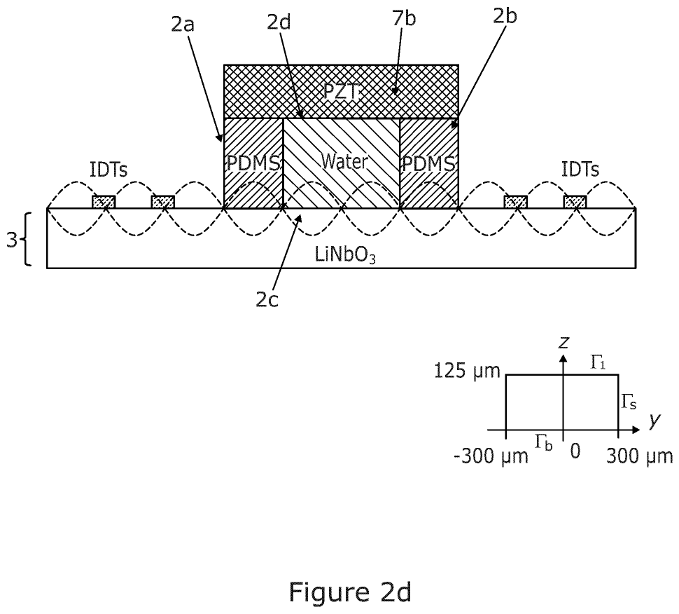

FIG. 3. Colour plots of the first-order acoustic pressure p₁, the first-order velocity field v₁ and the time-averaged second-order velocity [symbol] \hat{v}₂ [symbol] in the SAW-PDMS and SAW-Glass channels. (a) The maximum pressure in the SAW-PDMS and SAW-Glass is 13.4 kPa and 33.6 kPa, respectively. (b) The amplitude of the first-order velocity in the SAW-PDMS and SAW-Glass is 5.42 mm/s and 37.6 mm/s, respectively. (c) The maximum second-order velocity in the SAW-PDMS and SAW-Glass is 0.65 μm/s and 12.2 μm/s, respectively.

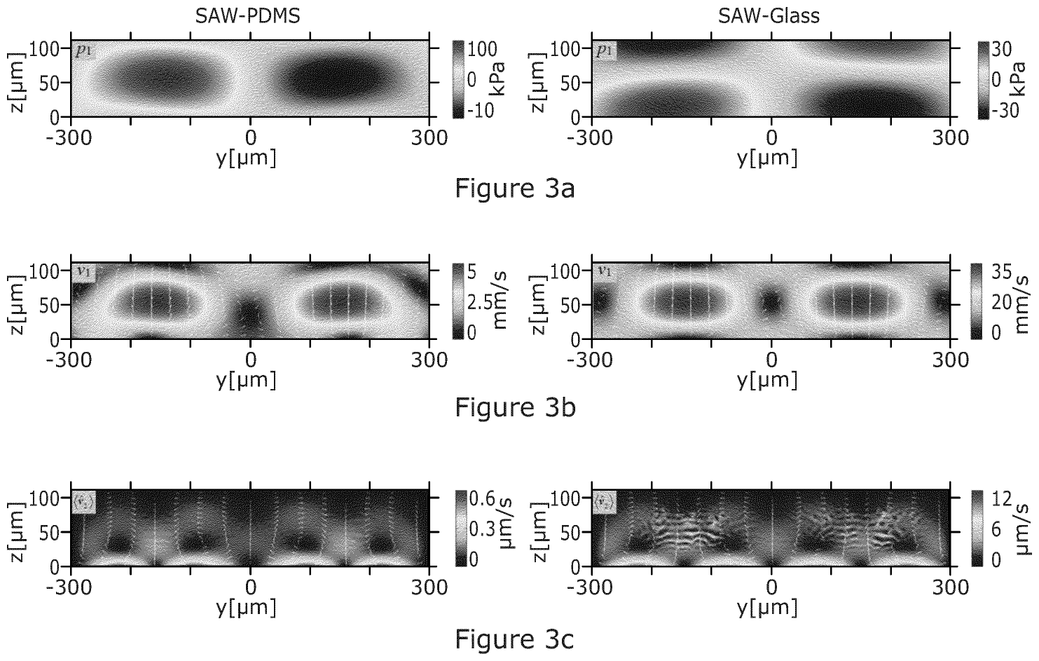

FIG. 4. Particle trajectories and velocities in the SAW-PDMS and SAW-Glass configurations. (a) Particle size is 1 μm, the maximum velocity is 0.55 μm/s in SAW-PDMS and 5.89 μm/s in SAW-Glass. (b) Particle size is 5 μm, the maximum velocity is 0.65 μm/s in SAW-PDMS and 10.7 μm/s in SAW-Glass. (c) Particle size is 10 μm, the maximum velocity is 10.4 μm/s in SAW-PDMS and 40.8 μm/s in SAW-Glass;

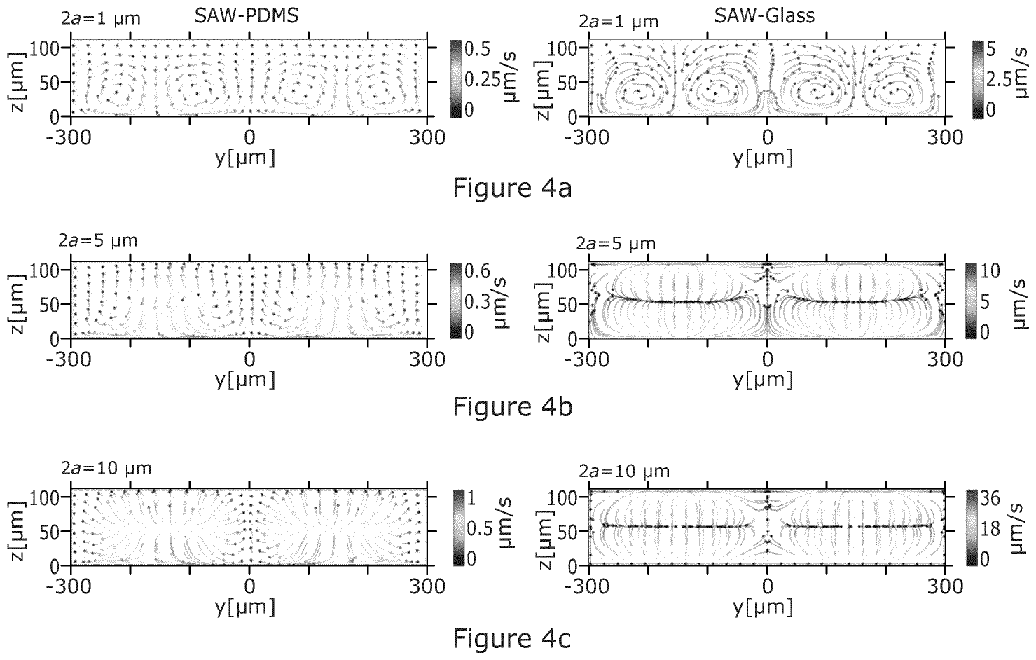

FIG. 5. Colour plots of the first-order acoustic pressure p₁, the first-order velocity field v₁ and the time-averaged second-order velocity [symbol] \hat{v}₂ [symbol] in the SAW-SAW channel. The left panel shows the phase difference Δφ=0 while the right panel shows the phase different Δφ=π. (a) The maximum pressure is 14.2 kPa and 224 kPa, respectively. (b) The amplitude of the first-order velocity is 2.0 mm/s and 70.6 mm/s, respectively. (c) The maximum second-order velocity is 0.88 μm/s and 41.5 μm/s, respectively;

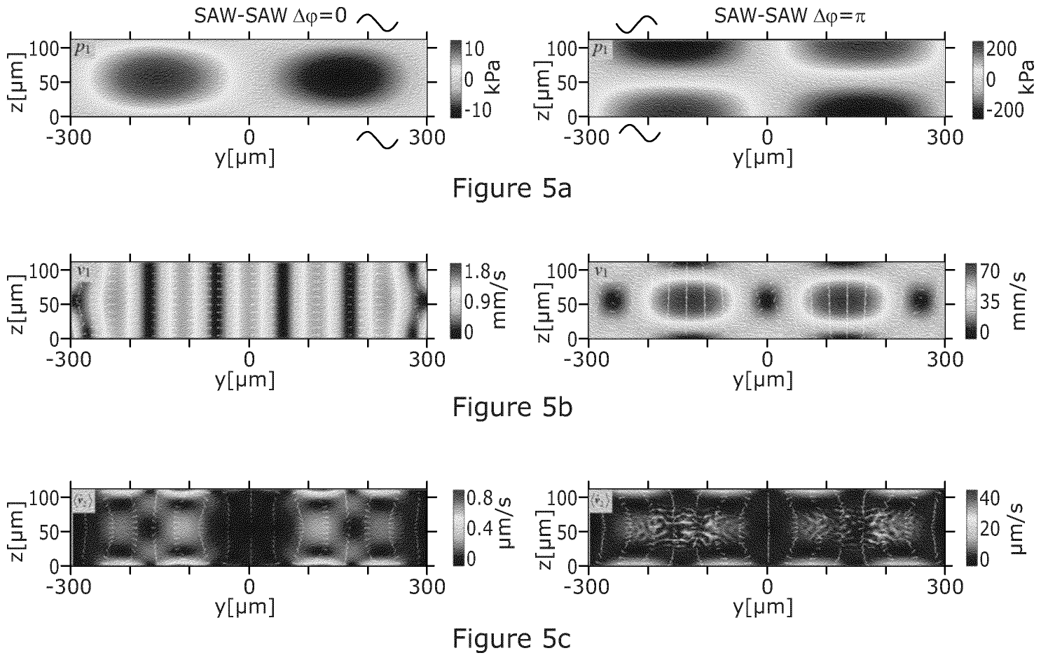

FIG. 6. Plots of the maximum first-order acoustic pressure p₁ (a) and the acoustic pressure distribution (b) for phase difference Δφ between 0 and 2π in the SAW-SAW configuration;

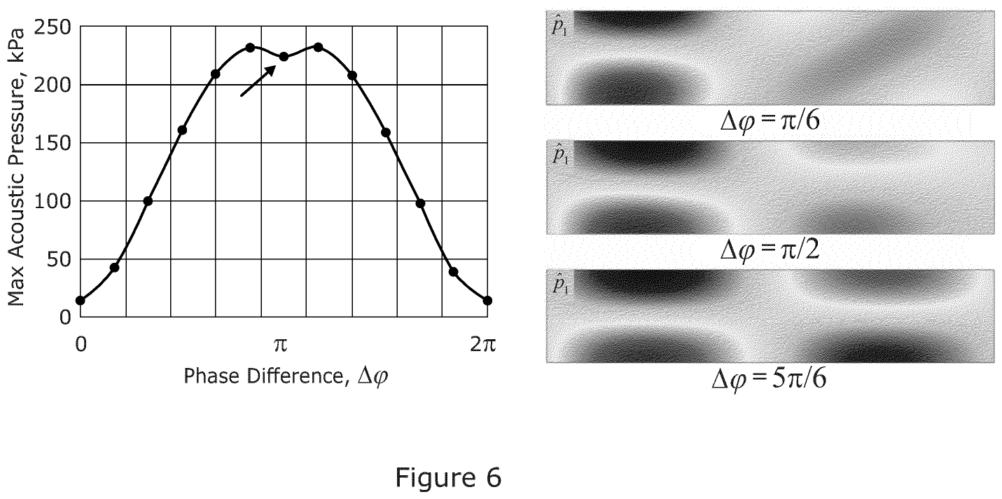

FIG. 7. Colour plots of the first-order acoustic pressure p₁ for the BAW-SAW configuration when the amplitude of the vibration of the BAW is (a) the same as the SAW transducer, and (b) 10 times higher than the SAW transducer;

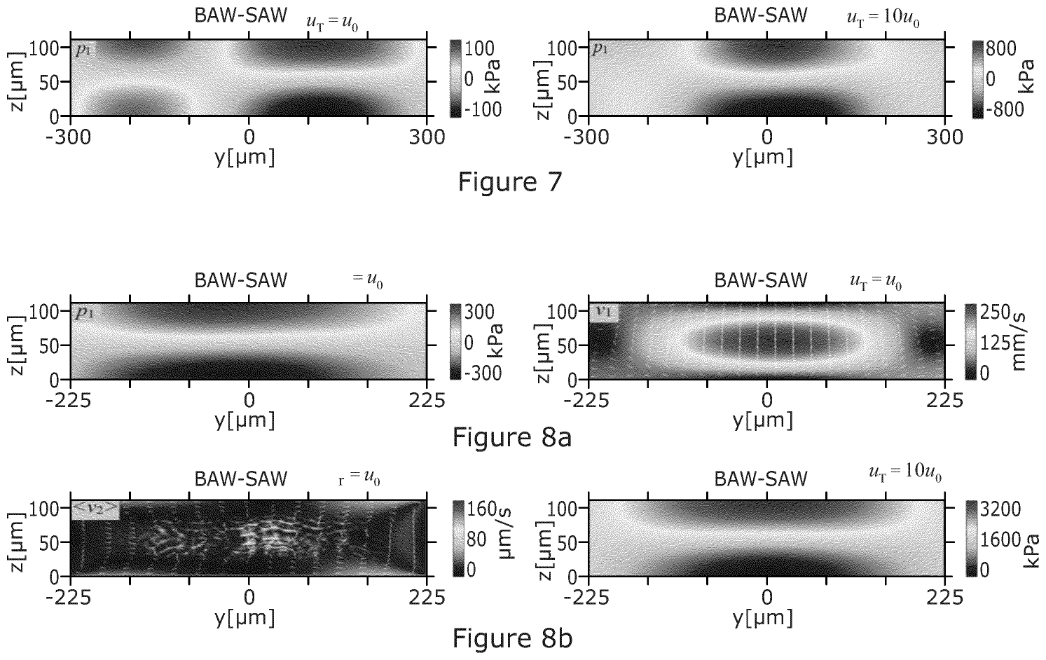

FIG. 8. Colour plots of the first-order acoustic pressure p₁, the first-order velocity field v₁ and the time-averaged second-order velocity [symbol] \hat{v}₂ [symbol] in the BAW-SAW configuration with the channel dimension of 450 μm×120 μm. (a) The maximum pressure is 373 kPa. (b) The maximum first-order velocity is 295 mm/s. (c) The maximum time-averaged second-order velocity is 161 μm/s. (d) The maximum pressure achieves 3,200 kPa when the BAW amplitude is ten times higher than the SAW;

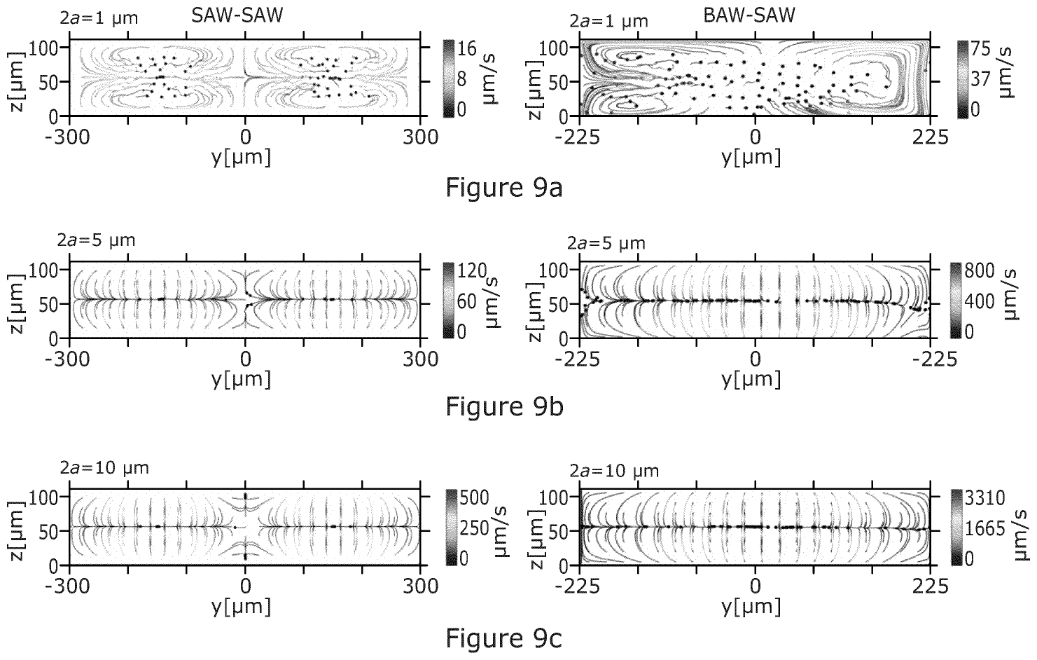

FIG. 9. Particle trajectories and velocities in the SAW-SAW (phase difference Δφ=π) and −SAW (uᵣ=10u₀) configurations. (a) Particle size is 1 μm, the maximum velocity is 17.5 μm/s in SAW-SAW and 80.1 μm/s in BAW-SAW. (b) Particle size is 5 μm, the maximum velocity is 131 μm/s in SAW-SAW and 847 μm/s in BAW-SAW. (c) Particle size is 10 μm, the maximum velocity is 573 μm/s in SAW-SAW and 3310 μm/s in BAW-SAW;

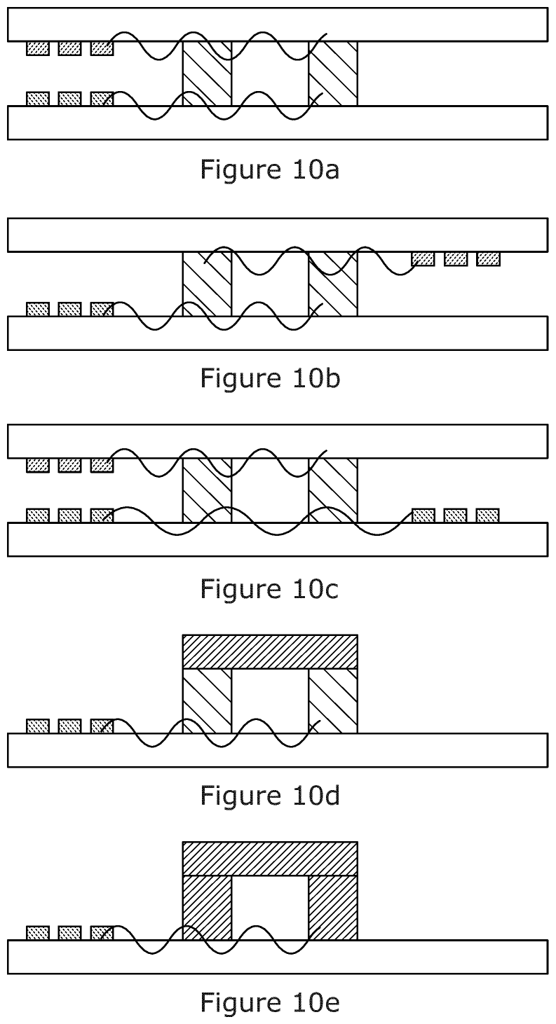

FIG. 10. Cross sectional side views of additional exemplary acoustofluidic devices according to the invention:

(A) An acoustofluidic configuration comprising PDMS channel sidewalls, a piezoelectric substrate top plate and a piezoelectric substrate bottom plate. A single IDT is deposited on the surface of each of the top and bottom plates, wherein the IDTs of the top and bottom plates are positioned adjacent to and on the same side of the channel sidewalls.

(B) An acoustofluidic configuration comprising PDMS channel sidewalls, a piezoelectric substrate top plate and a piezoelectric substrate bottom plate. A single IDT is deposited on the surface of each of the top and bottom plates, wherein the IDTs of the top and bottom plates are positioned adjacent to and on the opposite side of the channel sidewalls.

(C) An acoustofluidic configuration comprising PDMS channel sidewalls, a piezoelectric substrate top plate and a piezoelectric substrate bottom plate. A single IDT is deposited on the surface of the top plate, and a pair of IDTs forming a SSAW transducer are deposited on the surface of the bottom plate.

(D) An acoustofluidic configuration comprising PDMS channel sidewalls, a top BAW transducer and a piezoelectric bottom plate. A single IDT is deposited on the surface of the bottom plate, adjacent to the channel sidewalls.

(E) An acoustofluidic configuration comprising PZT (or any other piezoelectric substrate) sidewalls, a top BAW transducer and a piezoelectric bottom plate. A single IDT is deposited on the surface of the bottom plate, adjacent to the channel sidewalls. Alternatively, a pair of IDTs forming a SSAW transducer may be deposited on the surface of the bottom plate.

Table 1. Parameters used in numerical analysis at T=25° C.

Referring to the figures and, firstly, to FIG. 1 there is shown a partial side sectional diagrammatic view of an exemplar acoustofluidic device [1] according to an embodiment of the invention. It can be seen that a channel [2] is bonded to the surface of a piezoelectric substrate [3a] between ideally, although not exclusively, a pair of interdigitated transducers (IDTs) [3b] forming a SSAW transducer [3]. In this particular arrangement, at least one pair of IDTs [3b] is provided to generate at least one SSAW transducer [3]. As will be appreciated, alternative arrangements are envisaged such as where a single IDT [3b] or more than one pair of IDTs [3b] are provided to generate one of more SSAWs. The IDTs are routine in the art and comprise electrodes deposited on the surface of a piezoelectric substrate to form a periodic structure and, upon application of RF voltage, convert electric signals to surface acoustic waves (SAW) by generating periodically distributed mechanical forces via a piezoelectric effect causing the substrate to expand and contract. In the case of the present arrangement, when an RF voltage is applied to the pair of IDTs [3b] this generates two series of identical SAWs within the piezoelectric substrate that propagate in counter directions towards one another wherein they interfere to generate a SSAW field of periodic pressure nodes and antinodes in the space in between said pair of IDTs [3b] i.e. where the channel [2] is located, thereby exposing a flow stream in the channel to a standing acoustic wave field to affect acoustic fluid relocation of acoustically active particles contained therein.

As is shown in FIG. 1, the channel is configured such that the longitudinal axis of same is substantially orthogonal with respect to the IDTs [3b] such that acoustic waves generated by the IDTs [3b] are substantially transverse thus exposing any particles present in the fluid to lateral pressure force permitting generation of fluid flow paths that allow separation of particles according to shape and/or size.

As will be appreciated, to separate particles in a fluid it is required to provide fluid flow path through said channel [2] through which a fluid containing particles to be separated can flow. In FIG. 1, this is achieved by providing at least one fluid inlet [4] configured to introduce a fluid into a proximal end portion of the channel and at least one outlet [5] located at a downstream portion of the channel positioned substantially along the longitudinal axis of the channel. As will be appreciated by those skilled in the art, in this embodiment, a fluid can be introduced through the first inlet [4] and flowed through the at least one channel [2] and out of the fluid outlet [5]. Through exposure to the standing acoustic wave generated by the SSAW transducer [3] and/or acoustic wave source (best seen in FIG. 2), particles present in the fluid can be separated into different specific outlets [5] of the channel according to particle shape and/or size. As is shown, in a preferred arrangement the channel [2] comprises at least two outlets [5], although more or less outlets can be envisaged according to the particles to be separated. Preferably, as shown, said inlet(s) [4] and/or outlet(s) [5] are branched to permit separation of particles into different flow streams, although equally they may be unbranched. Further, the device may comprise a pump (not shown) to control flow rate of fluid through the inlet(s)/channel(s)/outlet(s). Also, by providing multiple inlets it is possible to introduce multiple fluids into the channel at any one time and so, in this arrangement, separate multiple particles from multiple fluid sources. In a preferred arrangement, said inlet(s) [4] and/or outlets(s) [5] are provided with tubing to permit flow of a fluid into the inlet(s) [4a] and/or out of the outlet(s) [5b].

According to the invention, as shown, a single channel [2] is provided to allow a single staged particle separation stage. However, in alternative arrangements it is envisaged that multiple stages of separation can be achieved. For example, a single channel [2] positioned between multiple staggered pairs of IDTs [3b] may be provided wherein each pair of IDTs [3b] produces a separate SSAW thereby providing differing fields of separation along the flow path. Alternatively, the device [1] comprises a plurality of channels [2] (not shown) in fluid communication with one another. Preferably, the channels are connected in series, so that each channel shares a connection with at least another channel, wherein the outlet of a first channel forms the inlet for the second, and so on. More preferably, each channel is connected via tubing. More preferably still each channel comprises a SSAW transducer such that each channel can separate different particles with respect to one another according to the standing wave generated for each respective channel. In this arrangement multi-stage particle separation can be achieved.

Turning to the channel, referring to FIG. 2, channel cross-sections of the art (FIGS. 2a and b) and according to the invention (FIGS. 2c and d) are shown as a side sectional diagrammatic views. In both arrangements (c and d), the channel comprises a first sidewall [2a] and second sidewall [2b], a floor [2c], and an acoustic waves source [7] defining the roof [2d]. In the embodiments shown, said channel floor [2c] is configured to functionally couple with the at least one SSAW transducer [3] such that the SSAW from the IDTs [3b] is propagated across same. As will be appreciated, in this preferred embodiment said floor [2c] of the channel [2] is provided by the piezoelectric substrate [3a] wherein the walls [2a/2b] of the channel [2] are bonded to the surface of the substrate [3a] to provide a channel. Alternatively (not shown), said channel floor and/or walls can be made from any suitable material that can house a fluid mixture and permits coupling of the acoustic wave energy from the piezoelectric substrate to the fluid in the channel. As is known by those skilled in the art, silicon, glass, or metal materials are commonly used for acoustophoresis because the rigid channel walls provide a near ideal acoustic boundary against the sample fluid, enhancing the required standing wave resonance. Such suitable materials for channel floor and/or wall include, but are not limited to, medical grade plastics, but most ideally, said channel walls and/or floor are PDMS.

With reference to the channel roof [2d], an acoustic wave source [7] refers to any means for generating acoustic wave energy wherein said acoustic wave energy is transmitted into the fluid of the channel [2]. In this way it is believed that by providing a roof [2d] defined by an acoustic wave source [7] one can further generate a vertical pressure field in the channel, in addition to the longitudinal pressure field induced by the orthogonal IDTs, producing another standing wave thereby increasing the channel pressure field. Further, the vertical channel pressure field also permits manipulation of particles in the vertical direction of the channel in addition to laterally.

In a first embodiment, as shown in FIG. 2c, the acoustic wave source [7] is provided as a further SSAW transducer [7a] thus forming two SSAW transducers (i.e. as the channel floor [3] and roof [7a]), termed SAW-SAW. Respectively, each SSAW transducer [3],[7a] can be independently controlled such that the acoustic waves generated by same can be carefully controlled to manipulate particle flow in both vertical and lateral planes thus providing for an extra level of particle flow separation. Preferably, to achieve higher resolution of particle flow and thus separation, it has been found that fine tuning the phase difference between each respective SSAW transducer one can generate symmetrical pressure anti-nodes to form good particle trajectories.

Alternatively, in a second embodiment as shown in FIG. 2d, the acoustic wave source is provided as a bulk acoustic piezoelectric transducer [7b] producing bulk acoustic waves (BAWs). In this arrangement (called BAW-SAW) the channel floor [2c] is provided by the SSAW transducer of the substrate and the roof [2d] is defined by a bulk acoustic (BAW) piezoelectric transducer [7b]. It has been found that in this particular arrangement one can also achieve stronger pressure gradients in the channel of several orders of magnitude greater than conventional arrangements known in the art. RF signals from a source (not shown) drive both the BAW [7b] and SSAW [3] transducers to produce a combined acoustic energy in the channel [2]. Changing the input voltage of the BAW [7b] and SSAW [3] transducers can vary the integrated acoustic field.

Therefore, as will be appreciated, in all embodiments the SSAW transducers [3] and/or acoustic wave source [7a, 7b] can be operated in phase with each other, or operated out of phase with each other depending on the configuration. Each SSAW transducer [3] and/or acoustic wave source [7a, 7b] of the present disclosure may have individual electrical attachments (e.g. electrodes), so that each SSAW transducer and/or acoustic wave source can be individually controlled for frequency and power. Configuration allows for not only the generation of a multi-dimensional acoustic standing wave, but also improved control of the acoustic standing wave. In this way, it is possible to drive individual transducers with arbitrary phasing and/or different or variable frequencies and/or in various out-of-phase modes.

As will be appreciated, the channel [2] takes the form predominantly of a longitudinal channel whose dimensions (height and width) can vary according to the nature of the fluid to be flowed therethrough, the number of particles to be separated, or respective number of inlet and outlet channels, for example. It has been found that where the channel dimensions are proportionally greater in width than height, maximum pressure field can be achieved across the entire cross-section of the channel allowing more careful particle manipulation. Ideally, said channel has a width between about 400-650 μm and a height between about 100-150 μm, although variations outside these ranges are possible and within the spirit of the invention.

The flow dynamics and particle separation of the devices according to the invention are described in the following examples.

Methods

When acoustic wave is applied to a suspension of particles, the scattering of the wave on the particles will exert an acoustic radiation force that can be utilised to manipulate the particles. To understand how the design of the acoustofluidic devices affects distribution patterns of the particles in a channel, we performed numerical simulations for different design scenarios. In all cases, the channel length is significantly longer than the height and the width, and the acoustic waves are perpendicular to the longitudinal direction. Thus, the fluid flow and particle movement in the channel are investigated as two-dimensional problems.

A. Governing Equations for Fluid Flow

For very dilute suspensions, influences of the particles on the bulk fluid flow can be neglected as long as the particle size is significantly smaller than the dimension of the channel and the acoustic wavelength. Thus, the governing equations for the bulk fluid flow are,

$$\begin{matrix}\frac{\partial \hat{ρ}}{\partial t} = - ∇ \cdot ( \hat{ρ} \hat{υ} ) & ( 1 ) \\ \hat{ρ} \frac{\partial \hat{υ}}{\partial t} = - ∇ \hat{p} - \hat{ρ} ( \hat{υ} \cdot ∇ ) \hat{υ} + η {∇}^{2} \hat{υ} + βη ∇ ( ∇ \cdot \hat{v} ) & ( 2 ) \\ β = \frac{{η}_{b}}{η} + \frac{1}{3} & ( 3 )\end{matrix}$$

where \hat{ρ} is the fluid density, the bold letter \hat{v} is the vector of fluid velocity, \hat{p} is the fluid pressure, η and η_{b} are the shear viscosity and bulk viscosity, respectively.

In our devices, there is no fluid flow before application of acoustic waves. As a result, the fluid density and pressure, ρ₀ and p₀, are uniform and time-independent. When acoustic waves propagate through the fluid, they cause small perturbations in the density, pressure, and velocity fields, which can be expressed as,

\hat{p}=p₀+\hat{p}₁+\hat{p}₂+ . . . (4)

\hat{ρ}=ρ₀+\hat{ρ}₁+\hat{p}₂+ . . . (5)

\hat{v}=\hat{v}₁+\hat{v}₂+ . . . (6)

where the subscripts 1 and 2 indicate the first and the second order terms, respectively. Higher order terms are neglected in the simulations. Additionally, we assume that \hat{p}₁ is proportional to \hat{ρ}₁,

\hat{p}₁=c₀²\hat{ρ}₁ (7)

where c₀ is a constant and approximately equal to the speed of sound in the fluid. Substituting Eq. (4) through (7) into Eq. (1) and Eq. (2) yields the continuity and momentum equations for the first- and second-order terms:

$$\begin{matrix} \frac{\partial {\hat{ρ}}_{1}}{\partial t} = - {ρ}_{0} ∇ \cdot {\hat{ν}}_{1} & ( 8 ) \\ {ρ}_{0} \frac{\partial {\hat{v}}_{1}}{\partial t} = - {c}_{0}^{2} ∇ {\hat{ρ}}_{1} + η {∇}^{2} {\hat{ν}}_{1} + β η ∇ ( ∇ \cdot {\hat{ν}}_{1} ) & ( 9 ) \\ \frac{\partial {\hat{ρ}}_{2}}{\partial t} = - {ρ}_{0} ∇ \cdot {\hat{ν}}_{2} - ∇ \cdot ( {\hat{ρ}}_{1} {\hat{ν}}_{1} ) & ( 10 ) \\ {ρ}_{0} \frac{\partial {\hat{v}}_{2}}{\partial t} = - ∇ {\hat{p}}_{2} + η {∇}^{2} {\hat{ν}}_{2} + β η ∇ ( ∇ \cdot {\hat{ν}}_{2} ) - {\hat{ρ}}_{1} \frac{\partial {\hat{v}}_{1}}{\partial t} - {ρ}_{0} ( {\hat{ν}}_{1} \cdot ∇ ) {\hat{ν}}_{1} & ( 11 )\end{matrix}$$

For periodic perturbations, the time average of the Eq. (10) and (11) become

$$\begin{matrix}{ρ}_{0} ∇ \cdot 〈 {\hat{ν}}_{2} 〉 = - ∇ \cdot 〈 {\hat{ρ}}_{1} {\hat{ν}}_{1} 〉 & ( 12 ) \\ η {∇}^{2} 〈 {\hat{ν}}_{2} 〉 + β η ∇ ( ∇ \cdot 〈 {\hat{ν}}_{2} 〉 ) - ∇ 〈 {\hat{p}}_{2} 〉 = 〈 {\hat{ρ}}_{1} \frac{\partial {\hat{v}}_{1}}{\partial t} 〉 + {ρ}_{0} 〈 ( {\hat{ν}}_{1} \cdot ∇ ) {\hat{ν}}_{1} 〉 & ( 13 )\end{matrix}$$

where [symbol] X [symbol] denotes the temporal average of X over an oscillation period. To solve the first order equations, Eq. (8) and Eq. (9) are first combined to obtain the governing equation for \hat{p}₁.

$$\frac{{\partial }^{2} {\hat{p}}_{1}}{\partial {t}^{2}} = {c}_{0}^{2} [ 1 + \frac{( 1 + β ) η}{{ρ}_{0} {c}_{0}^{2}} \frac{\partial }{\partial t} ] {∇}^{2} {\hat{p}}_{1} \qquad ( 14 )$$

In the study, we assume the first-order fields of the density, pressure, and velocity to be harmonic time dependence, i.e.

\hat{ρ}₁(r,t)=ρ₁(r)e^{iωt} (15)

\hat{p}₁(r,t)=e^{iωt} (16)

\hat{v}₁(r,t)=v₁(r)e^{iωt} (17)

where ω=2πf, which is the angular frequency, and f is the wave frequency. Substituting Eq. (15) through (17) into Eq. (9) and (14) yields,

$$\begin{matrix}i ω {ρ}_{0} {ν}_{1} = - ∇ {p}_{1} + η {∇}^{2} {ν}_{1} + β η ∇ ( ∇ \cdot {ν}_{1} ) & ( 18 ) \\ [ 1 + \frac{i ω ( 1 + β ) η}{{ρ}_{0} {c}_{0}^{2}} ] {∇}^{2} {p}_{1} + \frac{{ω}^{2}}{{c}_{0}^{2}} {p}_{1} = 0 & ( 19 )\end{matrix}$$

Eq. (19) can be solved with specific boundary conditions (see descriptions below) to obtain p₁, which can be substituted into Eq. (18) to determine the first order velocity, v₁(r). In the current study, however, we determined v₁(r) using an approximate method. Based on the Helmholtz decomposition theorem, a vector field can be separated into two terms: irrotational and solenoidal. Previous studies have shown that the second term for v₁ is negligible in the bulk fluid. It is important only within the boundary layer around a solid surface. Thus, we assumed v₁ to be irrotational in the bulk fluid, which can be expressed as the gradient of a velocity potential, v₁=∇ϕ₁. Substituting this relationship into Eq. (18) yields,

$${v}_{1} = - \frac{∇ {p}_{1}}{i ω {ρ}_{0}} [ 1 + \frac{i ω ( 1 + β ) η}{{ρ}_{0} {c}_{0}^{2}} ] \qquad ( 20 )$$

This is the equation used to calculate v₁ after solving the governing equation for p₁ (i.e., Eq. (19)).

B. Governing Equation for Acoustophoretic Trajectories of Particles

Once the first order acoustic pressure p₁ and velocity v₁ are obtained, we can determine the time-averaged acoustic radiation force F^{rad} on a spherical particle, which leads to the net movement of the particles besides local oscillation. F^{rad} is the sum of the second-order pressure and the first-order momentum flux integrated over the particle surface,

F^{rad}= [symbol] _{∂Ω} [symbol] n·[\hat{p}₂I+ρ₀(\hat{v}₁\hat{v}₁)] [symbol] dA (21)

where ∂Ω is a fixed surface in the bulk fluid around the particle. If the particle radius is much smaller than the wave length, an analytical expression of the force has been derived by Settnes and Bruus,

$${F}^{r a d} = - {πa}^{3} [ \frac{2 {κ}_{0}}{3} Re ( {f}_{1}^{*} {p}_{1}^{*} ∇ {p}_{1} ) - {ρ}_{0} Re ( {f}_{2}^{*} {ν}_{1}^{*} ∇ {ν}_{1} ) ] \qquad ( 22 )$$

where the asterisk denotes the complex conjugate of the quantity, a is the particle radius, and κ₀ is the isentropic compressibility of the fluid defined as

$${κ}_{0} = - \frac{1}{V} {( \frac{\partial V}{\partial \hat{p}} )}_{s} = \frac{1}{\hat{ρ}} {( \frac{\partial \hat{ρ}}{\partial \hat{p}} )}_{s} \qquad ( 23 )$$

where V and s are the volume and entropy of the fluid. After neglecting second and higher order terms, κ₀=1/(ρ₀c₀²). The scattering coefficients f₁ and f₂ are calculated by

$$\begin{matrix}{f}_{1} = 1 - \frac{{κ}_{p}}{{κ}_{0}} & ( 24 ) \\ {f}_{2} = \frac{2 ( 1 - γ ) ( {ρ}_{p} - {ρ}_{0} )}{2 {ρ}_{p} + {ρ}_{0} ( 1 - 3 γ )} & ( 25 ) \\ γ = - \frac{3}{2} [ 1 + i ( 1 + \frac{δ}{a} ) ] \frac{δ}{a} & ( 26 ) \\ δ = \sqrt{\frac{2 η}{ω {ρ}_{0}}} & ( 27 )\end{matrix}$$

where ρₚ and κₚ is the mass density and compressibility of the particle, respectively. δ is called the viscous penetration depth, which characterises the boundary layer thickness.

Apart from F^{rad}, particles also experience drag force from the viscous fluid due to the relative movement of the particle with respective to the fluid. Since the time-averaged streaming velocity is [symbol] \hat{v}₂ [symbol] , the time-averaged drag force is,

F^{drag}=6πηa( [symbol] \hat{v}₂ [symbol] −vₚ) (28)

where a is the particle radius and vₚ is the particle velocity vector. Applying the Newton's second law of motion to the particle yields,

$${m}_{p} \frac{{dv}_{p}}{dt} = {F}^{rad} + {F}^{drag} \qquad ( 29 )$$

where mₚ is the mass of the particle. In most experimental setup, the particle acceleration time is much shorter than the time scale of experimental observation. As a result, we can neglect the acceleration term in Eq. (29) to obtain an expression for vₚ:

$${ν}_{p} = 〈 {\hat{ν}}_{2} 〉 + \frac{{F}^{r a d}}{6 πη a} \qquad ( 30 )$$

Once [symbol] \hat{v}₂ [symbol] is determined by numerically solving Eq. (12) and Eq. (13) with the boundary conditions described below, Eq. (30) can be used to calculate the particle velocity.

C. Model Configurations and Boundary Conditions

C1. Model Configurations

The four different model configurations considered in this study are shown in FIG. 2(a-d). The typical SSAW transducer made by patterning a pair of interdigital electrodes on LiNbO₃ bonded with a PDMS channel is given in FIG. 2(a). Operating under the same RF signal, two SAWs generated by the IDTs counter-propagate to produce a standing SAW (SSAW) within the channel. Stable acoustic pressure gradients are formed in the water flowing in the channel which exerts acoustic radiation force and streaming drag force on the particles inside the channel. We call this typical acoustofluidic structure as SAW-PDMS. FIG. 2(b) shows the model of the novel structure of an acoustofluidic chip^{29, 30} for high throughput CTC separation, which employs a glass slide as an acoustic reflector attached on the top of the channel, namely hybrid PDMS-glass resonator (we call it SAW-Glass). The reflector prevents the acoustic energy loss caused by the PDMS absorption on the top.

To further increase the acoustic energy pressure in the channel for enhanced manipulation of particles, we developed two new models of acoustofluidic structures as shown in FIG. 2(c) and FIG. 2(d). In FIG. 2(c), the top wall of the PDMS channel is replaced by a second SSAW transducer which configures into a sandwich SSAW transducer spacing by PDMS walls, we call this structure as SAW-SAW, The SAW-SAW model can provide stronger pressure gradients in the channel by replacing the passive glass top with the active SSAW transducer. By tuning the phase difference between the top and bottom SSAW transducers, the acoustic pressure distribution can be controlled. The model shown in FIG. 2(d) is a variance of the sandwich structure by replacing the top wall with a BAW transducer producing acoustic wave into the water, namely BAW-SAW. The channel is constructed by two PDMS walls supporting the BAW transducer. RF signals are driving both the BAW and SSAW transducers to produce a combined acoustic energy in the channel. Changing the input voltage of the BAW and SSAW transducers can vary the integrated acoustic field. FIG. 2(e) shows the computational domain of the model, where the top (Γₜ) and bottom (Γ_{b}) boundaries are modelled differently using the displacement boundary condition in the SAW-SAW and BAW-SAW, and impedance boundary conditions are used to model the two PDMS side walls (Γₛ). All the parameters and values given in Table 1 are used in the numerical analysis.

C2. Boundary Conditions

To solve the first order pressure field, we employ the impendence or lossy-wall boundary condition at the water-PDMS interface, due to partial absorption of the acoustic energy by PDMS:

$$n \cdot ∇ {p}_{1} = i \frac{ω {ρ}_{0}}{{ρ}_{m} {c}_{m}} {p}_{1} \qquad ( 31 )$$

where ρₘ and cₘ are the mass density of PDMS and the speed of sound in PDMS, respectively. n is the normal vector of the solid boundary surface. The same lossy-wall boundary condition also applies to the water-glass interface shown in FIG. 2(b),

$$n \cdot ∇ {p}_{1} = i \frac{ω {ρ}_{0}}{{ρ}_{g} {c}_{g}} {p}_{1} \qquad ( 32 )$$

where ρ_{g} and c_{g} are the mass density of glass and the speed of sound in glass, respectively. To derive the boundary condition at the water-LiNbO₃ interface, we considered the LiNbO₃ substrate to be actuated by the SSAW, and ignored the wave decay along the propagation path in the substrate because of the short path length. Thus, the displacement and the velocity of the substrate in the z direction at the interface are,

û=u₀{e^{i(ωt-k}^{ₛ}^{y)}+e^{i[ωt-k}^{ₛ}^{(w}^{₀}^{-y)]}} (33)

\hat{v}=iωu₀{e^{i(ωt-k}^{ₛ}^{y)}+e^{i[ωt-k}^{ₛ}^{(w}^{₀}^{-y)]}} (34)

where u₀, t, kₛ, y and w₀ denote displacement amplitude, time, wave number, location on y-axis and channel width, respectively. The continuity of the displacement in the z direction requires the z component of the velocity to be continuous. Using Eq. (20), the boundary condition for p₁ at the water-LiNbO₃ interface is,

$$n \cdot ∇ {p}_{1} = \frac{{ω}^{2} {u}_{0} {ρ}_{0} [ {e}^{- i {k}_{s} y} + {e}^{- i {k}_{s} ( {w}_{0} - y )} ]}{[ 1 + \frac{i ω ( 1 + β ) η}{{ρ}_{0} {c}_{0}^{2}} ]} ( {e}_{z} \cdot n ) \qquad ( 35 )$$

where e_{z} is the unit vector in the z direction. In the design of the SAW-SAW configuration, the same attenuation boundary condition as that shown in Eq. (35) applies to both the top and the bottom boundaries.

For the water-PZT interface, we simulated the design in which PZT vibrated only in the z direction. Thus, the displacement and the velocity of the substrate at this interface are,

û=u_{T}e^{iωt} (36)

\hat{v}=iωu_{T}e^{iωt} (37)

where u_{T} denotes the maximum displacement amplitude of the PZT surface which is controlled by the applying RF voltage. Again, the continuity of the displacement in the normal direction at the interface requires the normal velocity to be continuous. Using Eq. (20), the boundary condition for p₁ at the water-PZT interface is,

$$n \cdot ∇ {p}_{1} = \frac{{ω}^{2} {u}_{T} {ρ}_{0}}{[ 1 + \frac{i ω ( 1 + β ) η}{{ρ}_{0} {c}_{0}^{2}} ]} ( {e}_{z} \cdot n ) \qquad ( 38 )$$

In the design with the BAW-SAW configuration, Eq. (38) and Eq. (34) apply to the top and the bottom boundaries respectively.

D. Numerical Simulations

Computational mesh with maximum element size length d_{b} at the domain boundary and 10 d_{b} in the bulk of the domain is reasonable to capture the physics of the model. We use an illustrative mesh with d_{b}=20δ, where δ is the viscous penetration depth defined in Eq. (27). For verifying the correctness of this solution, an investigation of the mesh-convergence is required. We compare a series of meshes with decreasing mesh element size length and define a relative convergence function C(g) for a solution g with respect to a reference solution g_{ref} taken to be the solution for the smallest value of d_{b}.

$$C ( g ) = \sqrt{\frac{\int {( g - {g}_{ref} )}^{2} d y d z}{\int {( {g}_{ref} )}^{2} d y d z}} \qquad ( 39 )$$

where we use a reference solution g_{ref} with d_{b}=0.4δ, which resulted in 2.2×10⁵ elements.

To simulate the flow and particle distribution patterns, we first solve Eq. (19) to determine the first order pressure field p₁ and use it to calculate the velocity field v₁ with Eq. (20). The results are substituted into Eq. (12) and Eq. (13) to solve for the time averaged, second order velocity field [symbol] \hat{v}₂ [symbol] . Finally, the particle velocity and trajcetories are calculated with Eq. (30).

Results

Acoustofluidic Field and Particle Trajectories in the SAW-PDMS and SAW-Glass

FIG. 3(a) shows the first-order pressure gradient p₁ inside the SAW-PDMS and SAW-Glass channels. The maximum pressure is 33.6 kPa in the SAW-Glass structure which has a similar pressure distribution reported by Wu's work²⁹, where the pressure anti-nodes located near the four corners of the channel. Comparing with the maximum pressure of 13.4 kPa in the SAW-PDMS, the higher acoustic pressure in the SAW-Glass channel is achieved attributing to the reflected acoustic energy at the water-glass interface.

FIG. 3(b) shows the first-order velocity v₁ inside the SAW-PDMS and SAW-Glass configurations, the amplitude of the actuation velocity is less than the amplitude of the first-order velocity |v₁| in both SAW-PDMS (5.42 mm/s) and SAW-Glass (37.6 mm/s) structures. The glass reflector produces 89% reflection at the water-glass interface allowing the acoustic wave to travel back to the channel, which results approximately 7-fold greater first-order velocity comparing to that in the SAW-PDMS configuration.

The time-averaged second-order velocities [symbol] v₂ [symbol] in the SAW-PDMS and SAW-Glass are given in FIG. 3(c), with the maximum velocity of 0.65 μm/s and 12.2 μm/s, respectively.

Acoustofluidic Field and Particle Trajectories in the SAW-SAW

In the SAW-Glass channel, the reflected wave from the water-glass interface interacts with the leaky wave in the water produced by the bottom SSAW transducer to produce a pseudo-standing wave (PSW) on the z direction. The PSW can be further improved and controlled by using another SSAW or BAW transducer such as PZT to replace the glass positioned on the top of the channel (FIG. 2(c) and FIG. 2(d)). In the SAW-SAW configuration, the phase difference, Δφ, between the two SSAWs generated on the top and the bottom SSAW devices can be controlled by a signal generator, which can enhance the acoustic energy within the channel and control the distribution of the pressure field. The first-order acoustic pressure p₁, the first-order velocity field v₁ and the time-averaged second-order velocity [symbol] \hat{v}₂ [symbol] in the SAW-SAW are given in FIG. 5, where the left panel and right panel show the results when Δφ=0 and Δφ=π, respectively.

Varying the phase difference Δφ between the top and bottom SSAW transducers can redistribute the pressure gradients and alter the pressure amplitude in the channel, due to the phase shift results in an interchange in the position of the nodes and the anti-nodes. By sweeping the Δφ, the maximum acoustic pressure and pressure gradients are shown in FIG. 6(a). The largest pressure of 232 kPa is obtained at Δφ=5π/6 and Δφ=7π/6 with four pressure anti-nodes (FIG. 6(b)), and the smallest pressure of 14.2 kPa is noted at Δφ=0 (FIG. 5(a)). The four pressure anti-nodes presented at Δφ=5π/6 or 7π/6 are not entirely symmetrical, which could not produce useful particle trajectories for particle separation. The maximum acoustic pressure at Δφ=π (red arrow in FIG. 6) is slightly lower but producing four symmetrical pressure anti-nodes (FIG. 5(a), right), which can form good particle trajectories (FIG. 9).

Acoustofluidic Field and Particle Trajectories in the BAW-SAW

By replacing the top SSAW transducer by the BAW transducer, such as PZT, as shown in FIG. 2(d), the hybrid device achieved even larger acoustic pressure and allowed more powerful particle manipulation. To allow high throughput particle manipulation by the primary acoustic radiation force to drive particles towards a belt like pressure node in the z direction, it is desired to have two pressure anti-nodes formed at the central top and bottom areas in the channel. For the same channel geometry used in the above simulations, i.e. 600 μm (W)×125 μm (H), when the BAW and the SSAW transducers produce the same vertical vibration amplitude, i.e. u_{T}=u₀, the pressure anti-nodes are asymmetrical as shown in FIG. 7(a). We increased the amplitude of the BAW to 10 times as the amplitude of the bottom SSAW transducer, i.e. u_{T}=10u₀, as shown in FIG. 7(b), the two pressure anti-nodes are formed.

The particle trajectories in the BAW-SAW configuration are simulated in FIG. 9 right panel, which can be compared with that in the SAW-SAW configuration shown in FIG. 9 left panel. Both configurations struggle to concentrate 1-μm particles due to the strong drag force dominating over the radiation force. Particles sized 5 and 10 μm are effectively driven by both the SAW-SAW and the BAW-SAW, the latter configuration displays much faster transition velocities achieving 847 μm/s and 3,310 μm/s for 5 and 10 μm, respectively.

### CONCLUSIONS

A comprehensive comparison amongst traditional SAW-PDMS, hybrid SAW-Glass, novel SAW-SAW and BAW-SAW structures have been presented in the study. The model of the SAW-SAW transducers has notably increased the 10-μm particle velocity to 573 μm/s, comparing to the velocity of 10.4 μm/s in the state-of-the-art hybrid SAW-Glass configuration. The active acoustic generation by the top SAW transducer instead of the passive glass reflection employs the same actuation boundary condition as the bottom IDT used in most of acoustofluidic devices. The BAW-SAW transducer whose piezoelectric material (e.g. PZT) can produce much greater vibration to incorporate with the bottom SSAW transducer allowing significantly stronger acoustic resonance generated in the channel. The 10-μm particles migrate at the maximum velocity of 3,310 μm/s when the BAW actuation amplitude is 10 times larger than the SAW actuation. The future work is to manufacture the SAW-SAW and BAW-SAW acoustofluidic chips to verify the model system and numerical analysis.

TABLE 1

| | | |
|---|---|---|
| Water | | |
| Density | ρ_{f} | 997 kg/m³ |
| Speed of sound | c₀ | 1497 m/s |
| Shear viscosity | η | 0.890 mPa s |
| Bulk viscosity | η_{b} | 2.47 mPa s |
| Compressibility | κ₀ | 448 T/Pa |
| Lithium niobite (LiNbO₃) | | |
| Speed of sound | c_{sub} | 3994 m/s |
| Poly-dimethylsiloxane (PDMS, 10:1) | | |
| Density | ρ_{wall} | 920 kg/m³ |
| Speed of sound | c_{wall} | 1076.5 m/s |
| Attenuation coeff. (6.65 MHz) | | 31 dB/cm |
| Polystyrene | | |
| Density | ρₚ | 1050 kg/m³ |
| Speed of sound | cₚ | 2350 m/s |
| Poisson’s ratio | σₚ | 0.35 |
| Compressibility | κₚ | 249 T/pa |
| Acoustic actuation parameters | | |
| Wavelength | λ | 600 nm |
| Forcing frequency | ƒ | 6.65 MHz |
| Displacement amplitude | μ₀ | 0.1 nm |
| Displacement decay coefficient | Cd | 116 m⁻¹ |
| Acoustic impedance | | |
| PDSM | Z_{PDMS} | 0.98 MPa · s/m |
| Water | Z_{water} | 1.49 MPa · s/m |
| Glass | Z_{glass} | 12.0 MPa · s/m |

### REFERENCES

29. M. Wu, P. H. Huang, R. Zhang, Z. Mao, C. Chen, G. Kemeny, P. Li, A. V. Lee, R. Gyanchandani, A. J. Armstrong, M. Dao, S. Suresh and T. J. Huang, Small (Weinheim an der Bergstrasse, Germany), 2018, 14, e1801131.
30. M. Wu, K. Chen, S. Yang, Z. Wang, P. H. Huang, J. Mai, Z. Y. Li and T. J. Huang, Lab on a chip, 2018, 18, 3003-3010.

1. An acoustofluidic device comprising:
at least one interdigitated transducer (IDT) deposited on the surface of a piezoelectric substrate; and
functionally coupled therewith at least one channel having a first end and second end forming a fluid flow path, wherein said at least one channel is positioned adjacent said at least one IDT and comprises a first sidewall; a second sidewall; a floor and an acoustic wave source defining a roof of the at least one channel.

2. The device according to claim 1 comprising at least a pair of interdigitated transducers (IDTs) deposited on the surface of a piezoelectric substrate to form at least one standing surface acoustic wave (SSAW) transducer wherein the at least one channel is positioned between said at least one pair of IDTs.

3. The device according to claim 1, wherein said piezoelectric substrate is: polyvinylidene difluoride (PVDF), gallium nitride (GaN), Aluminum nitride (AlN), silicon carbide (SiC), aluminum gallium nitride (AlGaN), Langasite (La3Ga5SiO₁₄), gallium orthophosphate (GaPO₄), a lithium niobate (LiNbO₃), lithium tantalate (LiTaO₃), barium titanate (BaTiO₃), lead zirconate titanate (Pb[ZrₓTi₁₋ₓ]O₃ with 0≤x≤1), potassium niobate (KNbO₃), sodium tungstate (Na2WO₃), or zinc oxide (ZnO).

4. (canceled)

5. The device according to claim 1, wherein a longitudinal axis of said at least one channel is substantially orthogonal with respect to said at least one IDT or is provided at an angle with respect to said at least one IDT.

6. (canceled)

7. (canceled)

8. The device according to claim 1, wherein said at least one channel floor and/or sidewalls is manufactured from: polycarbonates or polymethyl methacrylates, polyphenylsulfone (PPS), glass, silicone, ceramic, elastomers, thermoset polyester (TPE), poly-methyl methacrylate (PMMA), polystyrene (PS), polycarbonate (PC), poly-ethylene glycol diacrylate (PEGDA), teflons, polyurethane (PU), paper, hydrogels, pyrex or polydimethyl siloxane (PDMS).

9. (canceled)

10. The device according to claim 1, wherein said acoustic wave source is provided as a further (a) at least one interdigitated transducer (IDT) deposited on the surface of a piezoelectric substrate, (b) a standing surface acoustic wave (SSAW) transducer, or both.

11. (canceled)

12. The device according to claim 10, wherein said at least one IDT deposited on the surface of a piezoelectric substrate and said acoustic wave source are configured such that, in use, a phase difference of between about Δφ=π/2 and Δφ=3π/2 exists between the acoustic wave(s) originating in said piezoelectric substrate and the acoustic wave(s) originating in said roof of the at least one channel.

13. The device according to claim 12 wherein, in use, a phase difference of between about Δφ=π exists between the acoustic wave(s) originating in said piezoelectric substrate and the acoustic wave(s) originating in said roof of the at least one channel.

14. The device according to claim 1, wherein said acoustic wave source is provided as a bulk acoustic wave (BAW) piezoelectric transducer producing bulk acoustic waves (BAWs).

15. The device according to claim 14 wherein said BAW piezoelectric transducer is a piezoelectric ceramic.

16. The device according to claim 15 wherein said piezoelectric transducer is PZT or LiNbO₃.

17. The device according to claim 1, wherein said at least one channel has a width to height ratio of between about 10:1 and 1:1.

18. The device according to claim 1, wherein said at least one channel has a width between about 10-1000 μm and a height between about 1-250 μm including every 1 μm therebetween.

19. The device according to claim 1, wherein the at least one channel comprises at least one inlet configured to introduce a fluid into a proximal end portion of the at least one channel and/or at least one outlet which is located at a downstream portion of the at least one channel positioned substantially along the longitudinal axis of the at least one channel.

20. The device according to claim 19 wherein the at least one inlet and/or the at least one outlet is branched to permit separation of particles into different flow streams.

21. The device according to claim 1, wherein said device comprises a plurality of channels in fluid communication with one another.

22. The device according to claim 21 wherein each of the plurality of channels is functionally coupled with at least one IDT deposited on the surface of a piezoelectric substrate or a standing surface acoustic wave (SSAW) transducer such that each channel can separate different particles with respect to one another according to a standing wave generated for each respective channel.

23. The device according to claim 1, wherein the at least one IDT or a standing surface acoustic wave (SSAW) transducer and/or acoustic wave source can generate a resonance frequency, or a mean resonance frequency, of between about 100 KHz to 1000 MHz.

24. (canceled)

25. A method for separating a mixture of acoustically active particles comprising:
suspending a mixture of acoustically active particles in a liquid flow stream; and
flowing said liquid flow stream through the at least one channel of the device of claim 1, thereby separating the mixture of acoustically active particles.

26. An apparatus, comprising:
a signal generator configured to couple to an acoustofluidic device having (i) at least one interdigitated transducer (IDT) deposited on the surface of a piezoelectric substrate and (ii) at least one channel coupled to the IDT, wherein the at least one channel has a first end and second end forming a fluid flow path and wherein the at least one channel is positioned adjacent the at least one IDT and includes a first sidewall, a second sidewall, a floor, and an acoustic wave source defining a roof of the at least one channel;
wherein the signal generator is configured to produce a radio frequency (RF) voltage for the at least one IDT that controls a distribution of an acoustic pressure field within the at least one channel.
